(19) United States
(12) Patent Application Publication
(10) Pub. No.: US 2008/0162870 A1
(43) Pub. Date: Jul. 3, 2008

(54) Virtual Cluster Architecture And Method

(76) Inventors: Tay-Jyi Lin, Kaohsiung (TW); Chein-Wei Jen, Hsinchu (TW); Pi-Chen Hsiao, Taichung (TW); Li-Chun Lin, Pa-Te (TW); Chih-Wei Liu, Hsinchu (TW)

Correspondence Address: LIN & ASSOCIATES INTELLECTUAL PROPERTY, INC., P.O. BOX 2339, SARATOGA, CA, 95070-0339, US

(21) Appl. No.: 11/780,480

(22) Filed: Jul. 20, 2007

(30) Foreign Application Priority Data
Dec. 28, 2006 (TW) 095149505

(51) Int. Cl. G06F 15/00

(52) U.S. Cl. 712/1; 712/E09.001

(57) ABSTRACT

Disclosed is a virtual cluster architecture and method. The virtual cluster architecture includes N virtual clusters, N register files, M sets of function units, a virtual cluster control switch, and an inter-cluster communication mechanism. This invention uses a way of time sharing or time multiplexing to alternatively execute a single program thread across multiple parallel clusters. It minimizes the hardware resources for complicated forwarding circuitry or bypassing mechanism by greatly increasing the tolerance of instruction latency in the datapath. This invention may distribute function units serially into pipeline stages to support composite instructions. The performance and the code sizes of application programs can therefore be significantly improved with these composite instructions, of which the introduced latency can be completely hidden in this invention. This invention also has the advantage of being compatible with the program codes developed on conventional multi-cluster architectures.

### FIELD OF THE INVENTION

The present invention generally relates to a virtual cluster architecture and method.

### BACKGROUND OF THE INVENTION

The programmable digital signal processor (DSP) is playing an important role in the system-on-chip (SoC) design as wireless communication and multimedia applications grow. To meet the computation demand, processor designers usually explore the instruction-level parallelism and pipeline the datapath to reduce the critical path delay in datapath and increase the operating frequency. However, the side effect is the increase of instruction latency of the processor.

FIG. 1 shows a schematic view of a conventional processor datapath and the instruction latency of the pipeline. The upper part of FIG. 1 shows that the pipeline includes five stages: instruction fetch (IF) 101, instruction decode (ID) 102, execute (EX) 103, memory access (MEM) 104, and write back (WB) 105.

The pipeline will cause different instruction latencies. That is, a plurality of instructions following an instruction cannot use or know its computation result of that instruction. The processor must dynamically stall the successive dependent instructions or the programmer/compiler must avoid such instruction sequence. However, this leads to the overall performance degradation. There are four factors leading to instruction latency.

(1) the discrepancy of write and read operations on the register file (RF). As shown in the lower part of FIG. 1, an instruction stores the result to the RF in its fifth pipeline stage, while another instruction will read the RF at the second stage. Therefore, the consecutive four instructions cannot use the RF for passing data from the leading instruction. In other words, without forwarding or bypassing mechanism, all the instructions in the pipeline processor must suffer a 3-cycle instruction latency.

(2) the discrepancy of any data production and data consumption if full forwarding is implemented. For example, the third stage (EX) and the fourth stage (MEM) are the major data production and consumption points. That is, most arithmetic logic unit (ALU) instructions consume operands to produce a result at its third pipeline stage. “Load” instructions produce data while “store” instructions consume data at their fourth pipeline stage. When an ALU instruction follows a “load” instruction immediately and wants to use the result of that “load” instruction, it will suffer one-cycle latency.

In other words, even if the processor implements all the possible forwarding or bypassing paths, it is still impossible to eliminate all the instruction latency.

(3) the memory access latency. All operands for a programmable processor are obtained from memory. However, the memory access speed is not improved as much as the ALU as the semiconductor manufacturing process evolves. Therefore a memory access usually requires a plurality of cycles, and the discrepancy increases as the semiconductor manufacturing process improves. This is even more prominent in the very long instruction word (VLIW) architecture.

(4) the discrepancy of instruction fetch and branch decision points. The processor can identify the flow-changing instruction in the second stage (ID) at the earliest. If it is a conditional branch, it may ascertain the flow (i.e. continue execution or jump to branch point) until the third stage (EXE). This is called branch latency.

As aforementioned, the forwarding mechanism can reduce the instruction latency caused by data dependence. The instructions use the RF as the main data exchange mechanism, and the forwarding mechanism (or bypassing) provides the additional paths between the data producer and data consumer.

FIG. 2A shows a schematic view of the datapath of a single cluster with conventional pipeline organization and forwarding mechanism. The forwarding mechanism must compare the register index of computation results in every pipeline stages, and transmits the dependent data to the multiplexer prior to the data consumption point in time so that the following instructions need not to wait its operands to be written back to RF, instead, the ready instruction can receive the operand from the forwarding mechanism. As shown in FIG. 2A, the complete datapath includes all the data-generating function units (FU) of the pipeline, and the forwarding network. Forwarding unit 203 is responsible for inter-instruction operand comparison, and control signal generation for the multiplexers 205a-205d. Based on the control signal generated by forwarding unit 203, the multiplexers select RF 201 or forwarding mechanism to provide operands 207a, 207b for computation.

The forwarding unit 203 performs the comparison with RF 201 address, and transmits the control signal to all multiplexers 205a-205d prior to the operand-consuming sub-path multiplexers 205a-205d select the RF 201 or the forwarding unit 203 to provide operands 207a, 207b for computation.

The complete forwarding mechanism may consume considerable silicon area. As the number of data producers and consumers increases, the comparison circuit also grows significantly. In addition to the area increase of the multiplexers, the operating frequency is reduced due to the multiplexers on the critical path of processor. As the number of FUs in a high performance processor increases and the pipeline becomes deeper, the cost of providing complete forwarding mechanism becomes unrealistic.

As aforementioned, data forwarding or bypassing mechanism cannot eliminate all latencies due to the discrepancy of data production and data consumption points. Therefore, conventional architectures try to align FUs as much as possible to reduce the instruction latency. As shown in FIG. 2B, FUs 213a-213c are aligned of the same pipeline stage.

Instruction scheduling is to re-order the instruction execution sequence. By using “No Operation (NOP)”, the data-dependent instructions are separated to hide instruction latency. However, the instruction-level parallelism in application programs is limited, and it is difficult to fill all slots with the available parallel instructions.

In order to hide the increasing instruction latency the assembly programmer or the compiler intensively uses optimization techniques, such as, loop unrolling or software pipelining. But these techniques usually increase the size of code. Also, overly-long instruction latency cannot be entirely hidden by optimization technique so that some instruction slot is idling, which not only limits the performance of processor, but also wastes program memory as the code density is significantly reduced.

Increasing the number of parallel FUs with the cluster architecture is used in conventional processors, for improving their performance. FIG. 3A shows the schematic view of a multi-cluster architecture.

As shown in FIG. 3A, a multi-cluster architecture 300 uses the spatial locality to divide a plurality of FUs into N independent clusters, i.e., cluster 1 to cluster N. Each cluster includes an independent RF, i.e., RF 1 to RF N, to avoid the increase in hardware complexity caused by the increase of FUs. The FUs in a multi-cluster architecture 300 can only access the RF belonging to the cluster. The inter-cluster data access must go through additional inter-cluster communication (ICC) mechanism 303.

FIG. 3B shows an embodiment of a conventional 4-cluster architecture, i.e., N=4. The 4-cluster architecture includes four clusters, i.e., cluster 1 to cluster 4, with each cluster including two FUs, load/store unit (LS) and arithmetic unit (AU). Each FU has a corresponding instruction slot in the VLIW instruction. In other words, the architecture is an 8-issue VLIW processor. The eight instruction slots of the VLIW instruction in each cycle control the corresponding FUs of four clusters respectively.

VLIW1 to VLIW3 are issued in the multi-cluster architecture at cycle 1 to cycle 3 respectively. Take the LS in cluster 1 and VLIW1 as an example, the FU reads R1, performs “R1+8” and stores the result back to R1 at cycle 2, cycle 4, and cycle 5, assuming the pipeline organization in FIG. 1 is applied.

The multi-cluster architecture can be easily expanded or extended to accommodate the requirements by changing the number of clusters. Howeverm, the code compatibility between architectures with different number of clusters is also an important issue for extensibility, especially for the VLIW processor using static scheduling. Furthermore, the instruction latency problem of pipeline still exists in the multi-cluster architecture.

### SUMMARY OF THE INVENTION

The examples of the present invention may provide a virtual cluster architecture and method. The virtual cluster architecture uses time sharing or time multiplexing to alternatively execute multiple program threads of multiple parallel clusters in single physical cluster. It minimizes the hardware resources of complicated forwarding circuitry or bypassing mechanism by greatly increasing the tolerance of instruction latency in the datapath.

The virtual cluster architecture may include N virtual clusters, N register files, M sets of function units, a virtual cluster control switch and an inter-cluster communication mechanism. Both M and N are natural numbers. The virtual cluster architecture can decrease the number of clusters to reduce the hardware cost and the power consumption as the performance requirement changes.

The present invention distributes function units into serial pipeline stages to support composite instructions. The performance and the code sizes of application programs can therefore be significantly improved with these composite instructions, of which the introduced latency can be completely hidden in the present invention. The present invention also has the advantage of being compatible with the program codes developed on conventional multi-cluster architectures.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 shows a schematic view of a conventional processor datapath and the instruction latency of the pipeline.

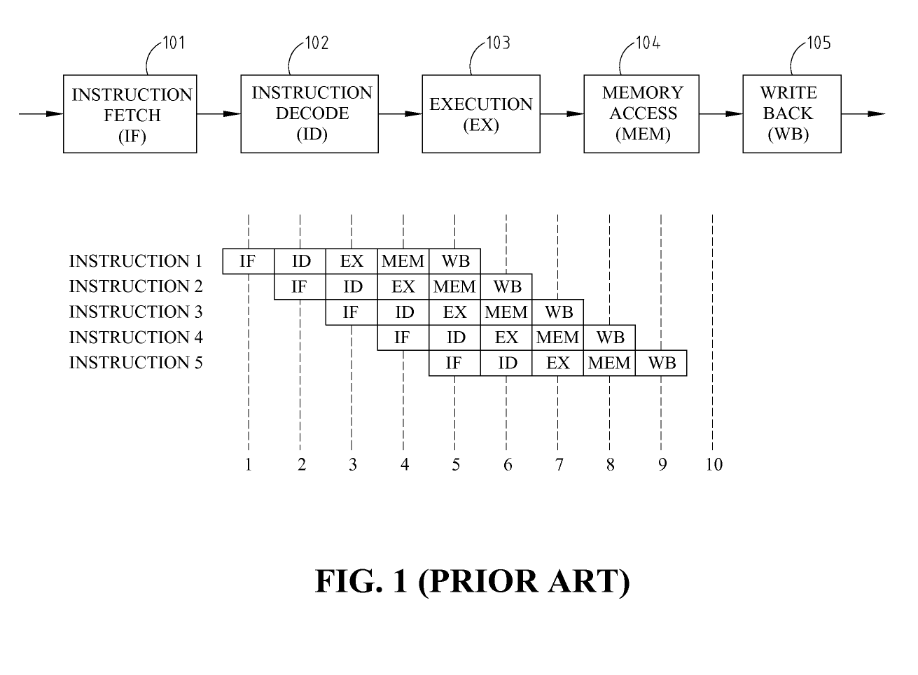

FIG. 2A shows a schematic view of the datapath of a single cluster with conventional pipeline organization and forwarding mechanism.

FIG. 2B shows an example of conventional FUs allocated in the pipeline stages.

FIG. 3A shows a schematic view of a multi-cluster architecture of a conventional processor.

FIG. 3B shows an example of a conventional architecture with 4 clusters.

FIG. 4 shows a schematic view of the virtual cluster architecture according to the present invention.

FIG. 5 shows a working example of the application of the present invention to reduce the 4-cluster architecture of FIG. 3B to a single physical cluster architecture.

FIG. 6 shows a schematic view of the pipelined datapath by taking two operands as an example in the virtual cluster architecture with a single physical cluster of FIG. 5.

FIG. 7 shows a schematic view of the pipeline stage allocation of the FUs of FIG. 6.

FIG. 8A shows a schematic view of a 4-cluster Pica DSP.

FIG. 8B shows the datapath pipeline of the virtual cluster architecture with a single physical cluster corresponding to FIG. 8A.

### DETAILED DESCRIPTION OF THE PREFERRED EMBODIMENTS

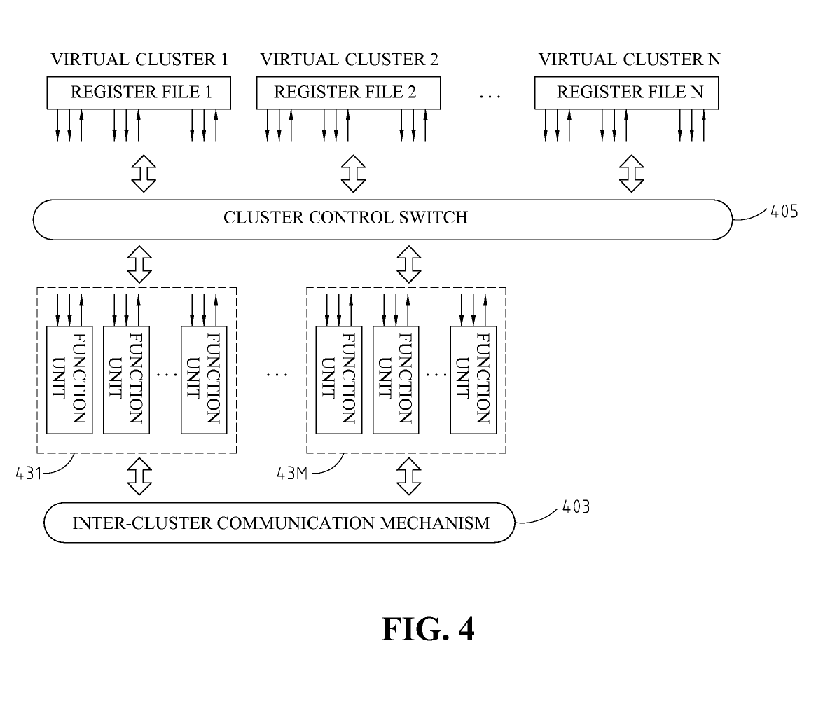

FIG. 4 shows a schematic view of the virtual cluster architecture according to the present invention. As shown in FIG. 4, the virtual cluster architecture includes N virtual clusters (virtual cluster 1-N), N register files (RF 1-N), M sets of function units (FUs) 431-43M, a virtual cluster control switch 405, and an inter-cluster communication mechanism 403. Both M and N are natural numbers. The N RFs store the input/output data of the M FUs. Virtual cluster control switch 405 switches the output data from the M sets of FUs to the N RFs. Similarly, the data stored in the N RFs are switched by virtual cluster control switch 405 to the M FUs for computation. Inter-cluster communication mechanism 403 is the bridge for the communication between virtual clusters, such as for data access.

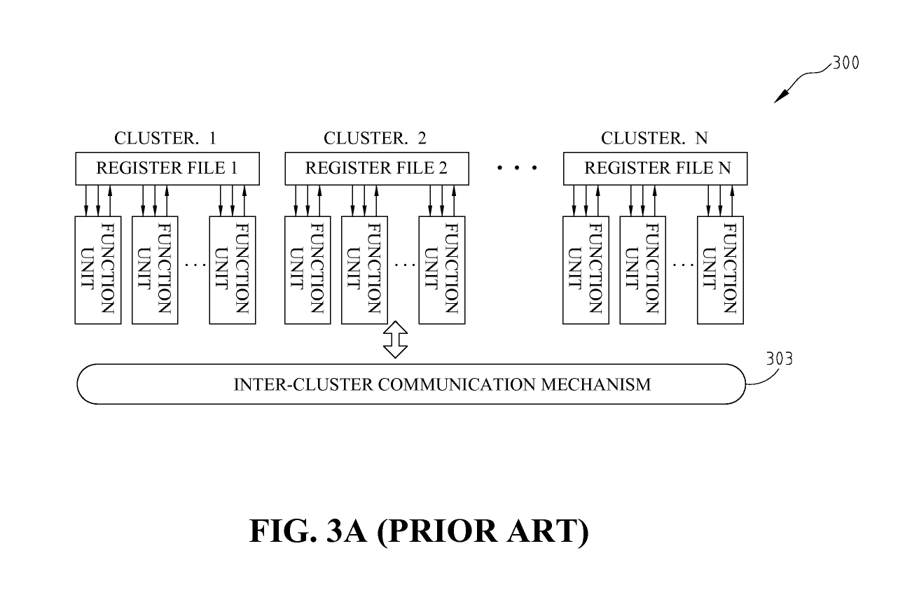

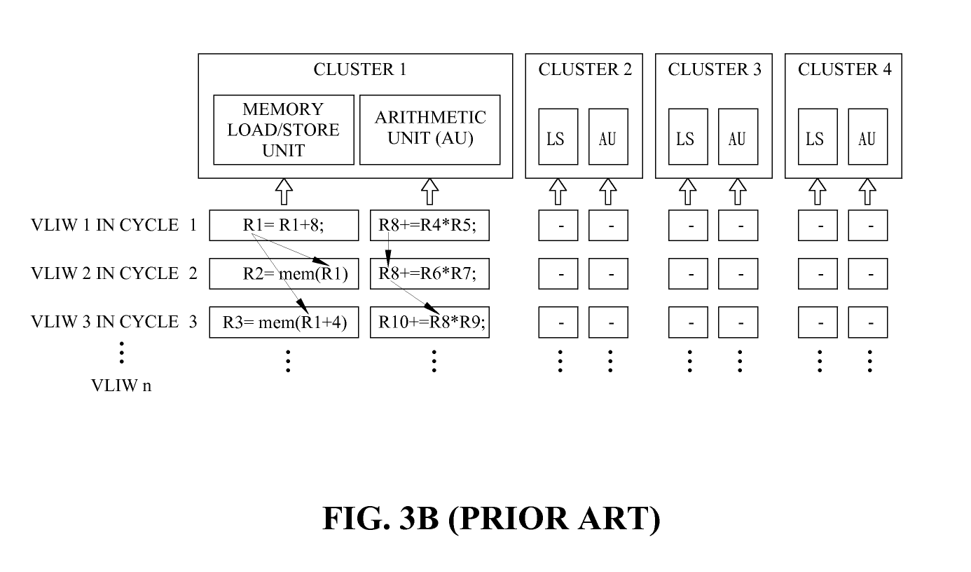

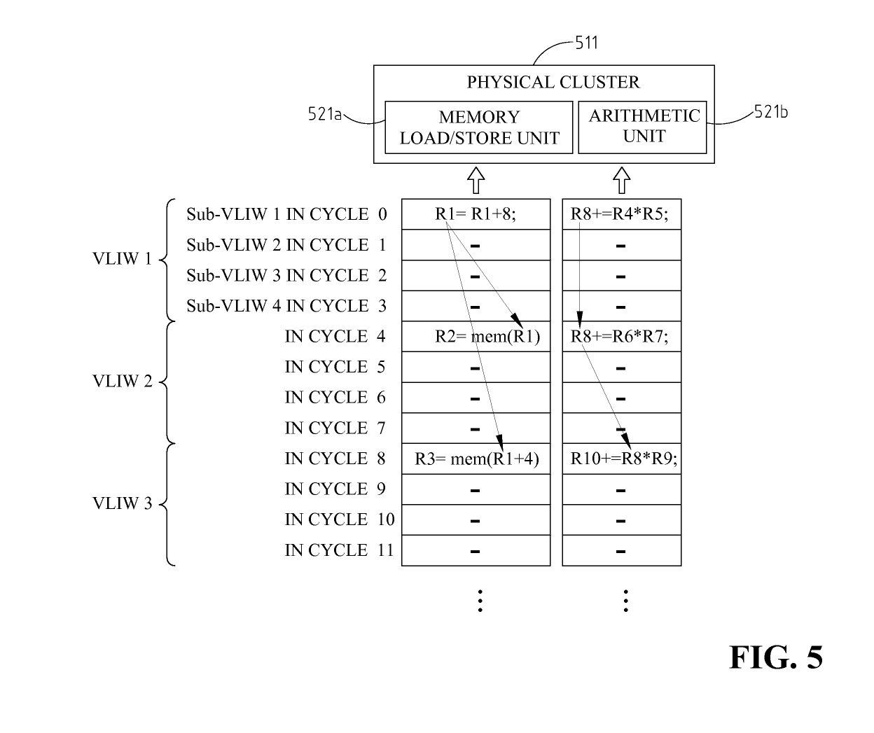

With the design of time multiplexing by virtual cluster control switch 405, such as a time sharing multiplexer, the virtual cluster architecture of the present invention can reduce the N clusters in a conventional processor to M physical clusters, i.e., M<=N, or even a single cluster. In addition, it is not necessary for each cluster to include a set of FUs. This reduces the hardware cost of the entire cluster architecture. FIG. 5 shows a working example of the application of the present invention to reduce the 4-cluster architecture of FIG. 3B to a single physical cluster architecture.

As shown in FIG. 5, the four clusters of FIG. 3B are folded into a single cluster, i.e., physical cluster 511. The physical cluster 511 includes a memory load/store unit 521a, and an AU 521b. The three sub-VLIW instructions, sub-VLIW1, of the original FIG. 3B are executed in cycle 0, cycle 4, and cycle 8, respectively in the single physical cluster architecture of FIG. 5. The results of the three sub-VLIW instructions are stored in R1-R10 of physical cluster 511. Therefore, the single cluster architecture with physical cluster 511 can tolerate 4-cycle instruction latency. Compared to FIG. 3B, the instructions of the working example of FIG. 5 are executed at ¼ of the original speed on the single physical cluster 511.

In other words, the VLIW instruction executed in one cycle on an N-cluster architecture requires N cycles to execute on a single physical cluster architecture. For example, the physical cluster can execute the sub-VLIW instruction of virtual cluster 0 in cycle 0, including reading the operands in the register of virtual cluster 0, using FUs to compute, and storing the result in the register of virtual cluster 0. All pipelined; that is, the three operations are executed in cycle −1, cycle 0, cycle 2. Similarly, the physical cluster executes the sub-VLIW instruction of virtual cluster 1 in cycle 1, sub-VLIW instruction of virtual cluster2 in cycle 2, . . . , and executes the sub-VLIW instruction of virtual cluster N-1 in cycle N-1. The physical cluster returns to virtual clusters 0 to execute the subsequent sub-VLIW instruction. With this design, the program code needs no changes to be executed on one virtual cluster architecture with a single physical cluster at 1/N of the original speed.

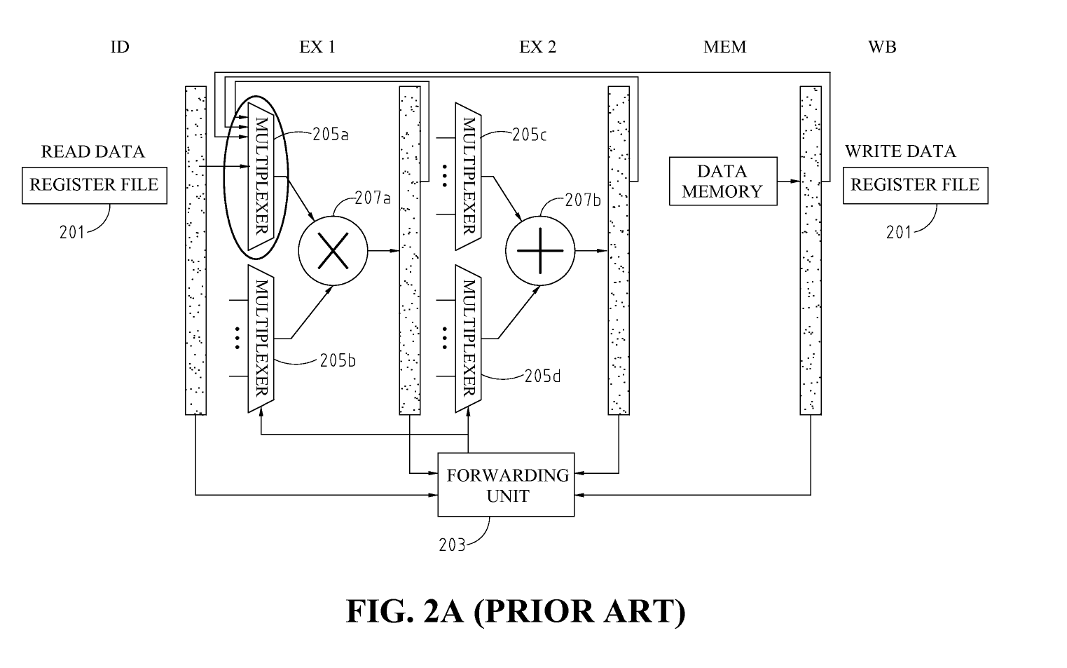

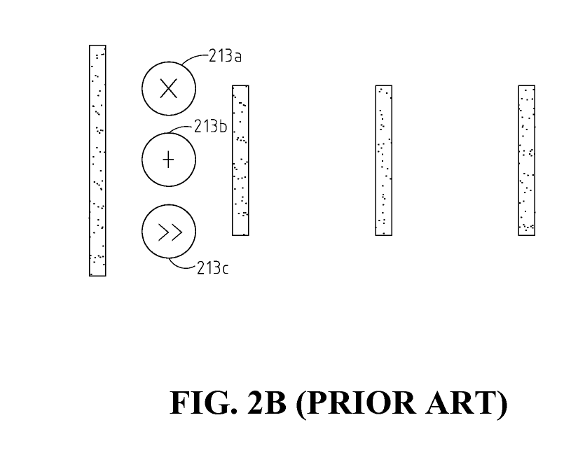

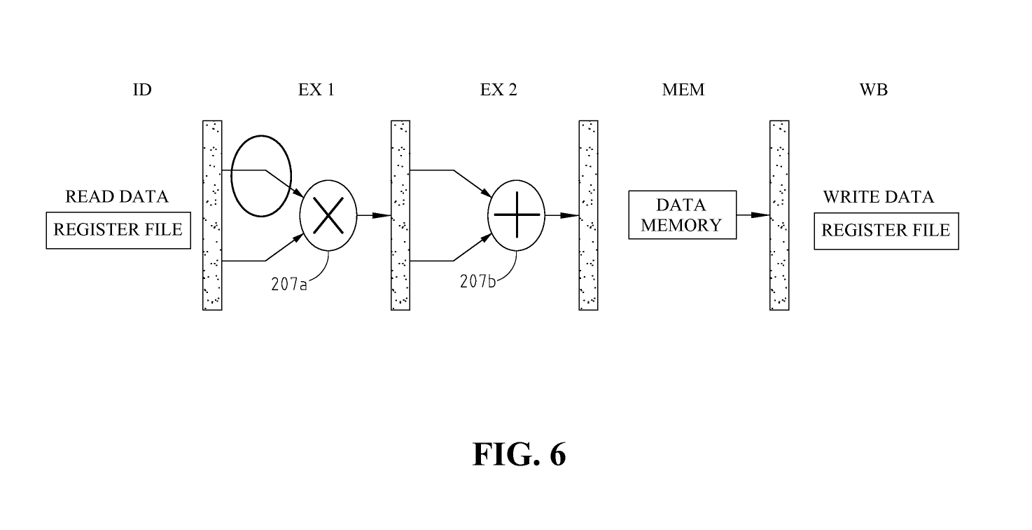

FIG. 6 shows a schematic view of the pipelined datapath by taking two operands 207a, 207b as an example in the virtual cluster architecture with a single physical cluster of FIG. 5. As shown in FIG. 6, the instructions in the datapath pipeline of the virtual cluster architecture are completely parallel, and no forwarding circuitry as the forwarding unit 203 of FIG. 2 is required. By exploring the execution discrepancy between the sub-VLIW instructions on the parallel clusters, the data dependence in the pipeline can be reduced so that the multiplexers in the pipeline between instruction execution 1 and instruction execution 2 to transmit the dependent data to the data consumption point can be simplified, as multiplexers 205a-205d of FIG. 2. If the number of the discrepant execution parallel sub-VLIW instructions is sufficient, the multiplexers prior to the FUs can entirely omitted.

Because the sub-VLIW instructions of parallel clusters in the virtual cluster architecture are execute discrepantly, i.e., not simultaneously, the data dependence in the pipeline is reduced. Therefore, the original non-causal data dependence that could not be solved by forwarding or bypassing mechanism previously, such as the ALU operation immediately following the memory loading, can now also be solved by forwarding or bypassing mechanism. If the number of the discrepant execution parallel sub-VLIW instructions is sufficient, the non-causal data dependence can be automatically solved without particular handling.

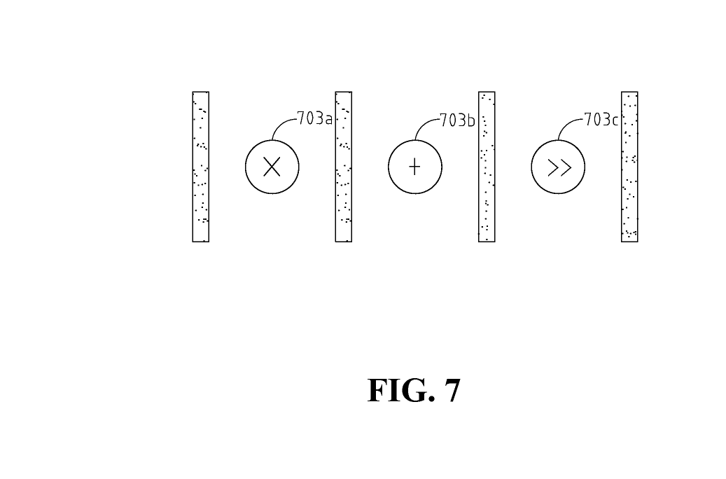

FIG. 7 shows a schematic view of the pipeline stage allocation of the FUs of FIG. 6. As the sub-VLIW instructions of the parallel clusters are executed discrepantly in the virtual cluster architecture, the data dependence in the pipeline is reduced so that FUs 703a-703c can be distributed to different pipeline stage in the virtual cluster architecture, as shown in FIG. 7. Hence, a processor based on the virtual cluster architecture of the present invention can use the FUs distributed in different pipeline stage to support composite instruction, such as multiply-accumulate (MAC) instruction, without additional FU. This allows each instruction to execute more operations, and improves the performance of the processor.

In summary, the present inventions uses only 1/N of the FUs of the high performance multi-architecture and the discrepant execution of parallel sub-VLIW instructions to simplify the forwarding or bypassing mechanism, eliminate the non-causal data dependence, and support a plurality of composite instructions. The hardware executes program code more efficiently (better than the 1/N of the performance of the multi-cluster architecture), improves the program code size (without the use of optimization technique to hide instruction latency), and is suitable for non-timing critical applications.

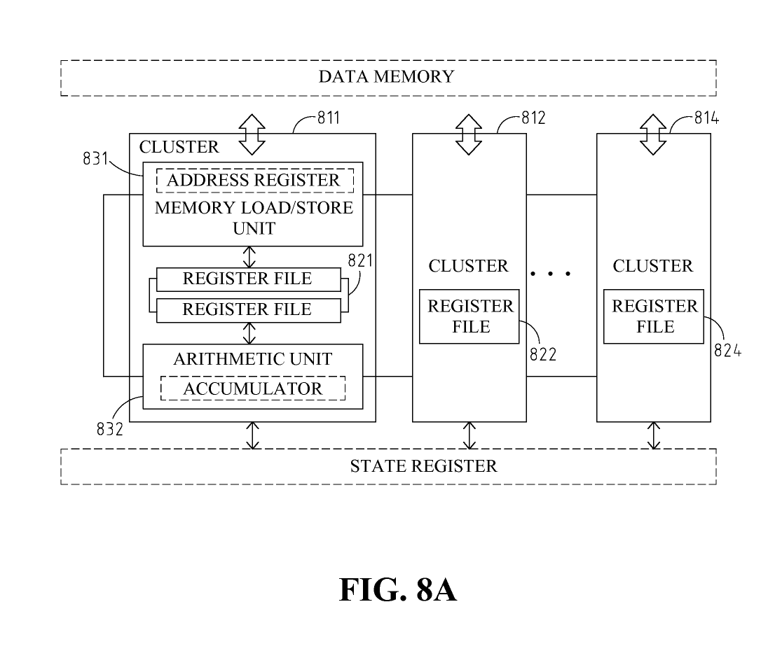

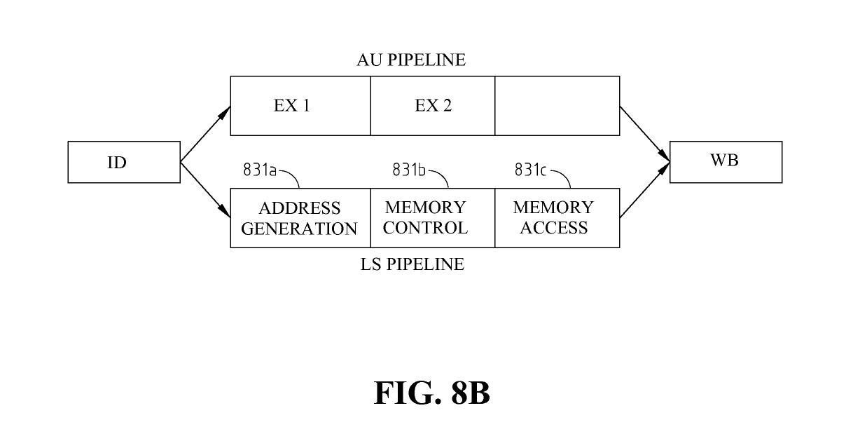

One of the working examples of the present invention is the datapath and corresponding virtual cluster architecture of the packed instruction and clustered architecture (Pica) digital signal processor (DSP). Pica is a high performance DSP with a plurality of symmetric clusters. Pica can adjust the number of clusters depending on the requirement, where each cluster includes a memory load/store unit, an AU, and a corresponding RF. Without the loss of generality, the working example shows a 4-cluster Pica DSP. FIG. 8A shows a schematic view of four clusters 811-814 of a 4-cluster Pica DSP.

As shown in FIG. 8A, each cluster, for example say 811, includes a memory load/store unit 831, an AU 832, and a corresponding RF 821. With the present invention, clusters 811-814 of the Pica DSP are folded into a corresponding physical cluster, and the four RFs 821-824 in the original clusters are kept. The datapath pipeline of the virtual cluster architecture with a single physical cluster is shown in FIG. 8B. Without loss of the generality, FIG. 8B shows an example of a 5-satge pipelined datapath.

As shown in FIG. 8B, the data production points are distributed among the instruction execution 1 and execution 2 stages of AU pipeline, and the stages of address generation (AG) 831a and MEM 831c of memory load/store (LS) pipeline. The data consumption points are distributed among the instruction execution 1 and execution 2 stages of AU pipeline, and the stages of AG 831a and memory control (MC) 831b of memory load/store pipeline

Other than the non-causal data dependence, the original complete forwarding routes of a single cluster of Pica DSP include 26 routes. With the present invention, the corresponding single physical cluster does not need any forwarding route, and can operate at a faster clock rate. Taking TSMC 0.13 um process as example, the clock rates of the two are 3.20 ns and 2.95 ns, respectively.

Because the non-causal data dependence does not exist in the virtual cluster architecture, the common DSP benchmarks has a smaller program code size and better normalized performance on the virtual cluster architecture.

The virtual cluster architecture of the present invention use time sharing to alternatively execute a single program thread across multiple parallel clusters. The original parallelism between the clusters can be explored to tolerate the instruction latency, and reduce the complicated forwarding or bypassing mechanism or additional hardware design because of the instruction latency.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A virtual cluster architecture, comprising:
N virtual clusters, N being a natural number;
M sets of function units (FUs), included in M physical clusters, M being a natural number;
N register files (RFs), for storing input/output data of said M FUs;
a virtual cluster control switch, for switching said input/output data of said M FUs to N RFs; and
an inter-cluster communication mechanism, for serving as a communication bridge between said N virtual clusters.

2. The virtual cluster architecture as claimed in claim 1, wherein M≦N.

3. The virtual cluster architecture as claimed in claim 1, wherein said virtual cluster control switch is implemented with one or more time sharing multiplexers.

4. The virtual cluster architecture as claimed in claim 1, wherein said M FUs are distributed among the stages of a corresponding datapath pipeline in said virtual cluster architecture.

5. The virtual cluster architecture as claimed in claim 1, wherein said virtual cluster architecture is configured as a single virtual cluster using time sharing to execute very long instruction word (VLIW) program codes.

6. The virtual cluster architecture as claimed in claim 1, wherein said virtual cluster architecture is configured as a plurality of virtual clusters using time sharing to execute very long instruction word (VLIW) program codes.

7. A virtual cluster method, comprising the steps of:
executing a program code through one or more virtual clusters in a time sharing way; and
distributing a plurality of sets of function units of said one or more virtual clusters among the stages of a corresponding datapath pipeline to support complicated composite instructions.

8. The virtual cluster method as claimed in claim 7, further including the step of switching the output data from said plurality of sets of function units through a virtual cluster control switch.

9. The virtual cluster method as claimed in claim 7, wherein said program code is a program code of very long instruction word.

10. The method as claimed in claim 7, wherein said program code is a program code for K clusters, and K≧2.

11. The method as claimed in claim 10, wherein the number of said one or more virtual clusters is not greater than K.
